(19) United States
(12) Patent Application Publication
(10) Pub. No.: US 2007/0219092 A1
(43) Pub. Date: Sep. 20, 2007

(54) Catalyst supporting body

(75) Inventors: Yusuke Hatanaka, Shizuoka (JP); Yoshinori Hotta, Aichi (JP); Hirokazu Sawada, Shizuoka (JP); Akio Uesugi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/723,250

(22) Filed: Mar. 19, 2007

(30) Foreign Application Priority Data
Mar. 20, 2006 (JP) 2006-076152

(51) Int. Cl. B01J 21/04

(52) U.S. Cl. 502/439

(57) ABSTRACT

There is provided a catalyst supporting body including a porous alumina support and a catalyst supported on the porous alumina support in which the surface of the porous alumina support has at least one selected from the group consisting of irregularities having an average wavelength of 5 to 100 μm, irregularities having an average wavelength of 0.5 to 5 μm, and irregularities having an average wavelength of 0.01 to 0.5 μm. The catalyst supporting body has an excellent catalytic function.

### BACKGROUND OF THE INVENTION

The present invention relates to a catalyst supporting body and a catalyst unit using the same.

In the technical field of metal and semiconductor thin films, wires and dots, it is known that the movement of free electrons becomes confined at sizes smaller than some characteristic length, as a result of which singular electrical, optical and chemical phenomena become observable. Such phenomena are called “quantum mechanical size effects” or simply “quantum size effects.” Functional materials which employ such singular phenomena are under active research and development. Specifically, materials having structures smaller than several hundred nanometers in size, typically called microstructures or nanostructures, are the subject of current efforts in material development.

Methods for manufacturing such microstructures include processes in which a nanostructure is directly manufactured by semiconductor fabrication technology, including micropatterning technology such as photolithography, electron beam lithography, or x-ray lithography.

Of particular note is the considerable amount of research being conducted today on processes for manufacturing nanostructures having an ordered microstructure.

One method of forming an ordered structure in a self-regulating manner is illustrated by an anodized alumina layer (anodized layer) obtained by subjecting aluminum to anodizing treatment in an electrolytic solution. It is known that a plurality of micropores having diameters of about several nanometers to about several hundreds of nanometers are formed in a regular arrangement within the anodized layer. It is also known that when a completely ordered arrangement is obtained by the self-pore-ordering treatment of this anodized layer, hexagonal columnar cells will be theoretically formed, each cell having a base in the shape of a regular hexagon centered on a micropore, and that the lines connecting neighboring micropores will form equilateral triangles.

Catalyst supporting bodies are known as an exemplary application for such anodized layers having micropores. For example, JP 2528701 B (the term “JP ______ B” as used herein means a “Japanese patent”) describes a method of producing a thermally conductive catalyst body characterized in that a porous alumina layer is formed on an aluminum surface of a thermally conductive support that has an aluminum layer with a thickness of at least 10 μm, formation of the alumina layer is followed by hot water treatment at a temperature of 50° C. to 350° C., and a metal having a catalytic activity is supported on the alumina layer after hot water treatment has been performed or while hot water treatment is being performed.

### SUMMARY OF THE INVENTION

The inventors of the present invention have made studies and found that the catalyst body obtained by the method described in JP 2528701 B has a low catalytic function.

It is therefore an object of the present invention to provide a catalyst supporting body having an excellent catalytic function. Another object of the invention is to provide a catalyst unit using the catalyst supporting body described above.

The inventors of the present invention have made intensive studies to achieve the above objects and found that a catalyst supporting body that includes a porous alumina support whose surface has irregularities of specific sizes and a catalyst supported in the porous alumina support is extremely excellent in catalytic function. The present invention has been completed on the basis of such finding.

Accordingly, the present invention provides the following (i) to (iv).
(i) A catalyst supporting body comprising:

a porous alumina support; and

a catalyst supported on the porous alumina support,

wherein a surface of the porous alumina support has at least one selected from the group consisting of irregularities having an average wavelength of 5 to 100 μm, irregularities having an average wavelength of 0.5 to 5 μm, and irregularities having an average wavelength of 0.01 to 0.5 μm.
(ii) The catalyst supporting body according to (i) above, wherein the surface of the porous alumina support has a difference in surface area ΔS represented by formula (1):

ΔS=[(Sₓ−S₀)/S₀]×100(%) (1)

wherein Sₓ is the actual surface area of a 50 μm square surface region as determined by three-point approximation from three-dimensional data on the surface region measured with an atomic force microscope at 512×512 points and S₀ is the geometrically measured surface area of the surface region, of at least 5%.
(iii) A catalyst unit having the catalyst supporting body according to (i) above.
(iv) A catalyst unit having the catalyst supporting body according to (ii) above.

The catalyst supporting body of the invention has an excellent catalytic function.

### BRIEF DESCRIPTION OF THE DRAWINGS

In the accompanying drawings:

FIG. 1 is a graph showing an example of an alternating current waveform that may be used in electrochemical graining treatment in producing a catalyst supporting body of the present invention;

FIG. 2 is a side view of an example of a radial electrolytic cell that may be used to carry out electrochemical graining treatment with alternating current in producing the catalyst supporting body of the present invention;

FIG. 3 is a schematic view of an anodizing apparatus that may be used in anodizing treatment in producing the catalyst supporting body of the present invention; and

FIG. 4 is a side view conceptually showing a brush graining step that may be used in mechanical graining treatment when the catalyst supporting body of the present invention is produced.

### DETAILED DESCRIPTION OF THE INVENTION

The invention is described more fully below.

The catalyst supporting body of the present invention includes a porous alumina support; and a catalyst supported on the porous alumina support, and a surface of the porous alumina support has at least one selected from the group consisting of irregularities having an average wavelength of 5 to 100 μm, irregularities having an average wavelength of 0.5 to 5 μm, and irregularities having an average wavelength of 0.01 to 0.5 μm.

### <Porous Alumina Support>

### <Surface Profile>

The surface of the porous alumina support that may be used in the present invention has at least one selected from the group consisting of irregularities having an average wavelength of 5 to 100 μm, irregularities having an average wavelength of 0.5 to 5 μm, and irregularities having an average wavelength of 0.01 to 0.5 μm.

Such irregularities provided to the surface of the porous alumina support increase the specific surface area, and as a result, the porous alumina support can support a catalyst to be described later in a large amount. Therefore, the catalyst supporting body of the present invention has an excellent catalytic function. The amount of catalyst that may be supported by a conventional catalyst supporting body that uses a porous alumina layer formed on an aluminum surface (for example, the catalyst body obtained by the method described in JP 2528701 B) is smaller than that in the catalyst supporting body of the present invention.

The catalyst supporting body of the present invention is excellent in the catalytic function per amount of supported catalyst, presumably because a reactive material (e.g., reactive gas) or carrier gas near a catalyst flows more smoothly in a reaction system using the catalyst owing to the aforementioned irregularities formed on the porous alumina support, which allows the reactive material to efficiently approach the catalyst, resulting in a higher reaction efficiency. A conventional catalyst supporting body which uses a porous alumina layer on an aluminum surface (e.g., catalyst body obtained by the method described in JP 2528701 B) suffers from unsmooth flowing of a reactive material or carrier gas near a catalyst and hence low reaction efficiency.

The irregularities having an average wavelength of 5 to 100 μm (hereinafter referred to simply as “large-wave structure”) preferably have an average wavelength of 7 to 75 μm and more preferably 10 to 50 μm in consideration of smoother flowing of the reaction material.

The irregularities having an average wavelength of 0.5 to 5 μm (hereinafter referred to simply as “medium-wave structure) preferably have an average wavelength of 0.7 to 4 μm and more preferably 1 to 3 μm in consideration of a larger specific surface area and smoother flowing of the reactive material.

The irregularities having an average wavelength of 0.01 to 0.5 μm (hereinafter referred to simply as “small-wave structure”) preferably have an average wavelength of 0.015 to 0.4 μm and more preferably 0.02 to 0.3 μm in consideration of a larger specific surface area.

The surface of the porous alumina support has at least one selected from the group consisting of the aforementioned large-wave structure, medium-wave structure and small wave structure. However, the surface of the porous alumina support is preferably formed by superimposing two or three of these structures on one another and more preferably by superimposing all the three structures on one another.

The surface of the porous alumina support has a difference in surface area ΔS represented by formula (1):

ΔS=[(Sₓ−S₀)/S₀]×100(%) (1)

wherein Sₓ is the actual surface area of a 50 μm square surface region as determined by three-point approximation from three-dimensional data on the surface region measured with an atomic force microscope (AFM) at 512×512 points and S₀ is the geometrically measured surface area (apparent surface area) of the surface region, of preferably at least 5%, more preferably at least 10% and even more preferably at least 20%.

The difference in surface area ΔS is one of the factors that show the magnitude of the irregularities on the surface of the porous alumina support. At a larger difference in surface area ΔS, the catalyst to be described later can be supported in a larger amount, thus acting more efficiently.

In the present invention, the surface profile is measured with the atomic force microscope to obtain three-dimensional data to thereby determine ΔS. Measurement can be carried out, for example, under the following conditions.

More specifically, a 1 cm square sample is cut out from the porous alumina support and placed on a horizontal sample holder mounted on a piezo scanner. A cantilever is then made to approach the surface of the sample. When the cantilever reaches the zone where interatomic forces are appreciable, the surface of the sample is scanned in the X and Y directions, and the surface topography of the sample is read based on the displacement in the Z direction. A piezo scanner capable of scanning 150 μm in the X and Y directions and 10 μm in the Z direction is used. A cantilever having a resonance frequency of 120 to 150 kHz and a spring constant of 12 to 20 N/m (e.g., SI-DF20 manufactured by NANOPROBE) is used, with measurement being carried out in the dynamic force mode (DFM). The three-dimensional data obtained is approximated by the least-squares method to compensate for slight tilting of the sample and determine a reference plane. Measurement involves obtaining values of 50 μm square regions on the surface of the sample at 512 by 512 points. The resolution is 1.9 μm in the X and Y directions, and 1 nm in the Z direction. The scan rate is 60 μm/s.

Next, using the three-dimensional data f(x,y) obtained above, sets of adjacent three points are selected and the surface areas of microtriangles formed by the sets of three points are summated, thereby giving the actual surface area Sₓ. The difference in surface area ΔS is then calculated from the resulting actual surface area Sₓ and the geometrically measured surface area S₀ using formula (1) above.

There is no particular limitation on the method of producing the porous alumina support having the aforementioned surface profile. For example, the porous alumina support may be obtained by subjecting an aluminum plate to surface treatments including surface graining treatment and anodizing treatment.

### <Aluminum Plate>

A known aluminum plate may be used to produce the porous alumina support in the present invention. The aluminum plate used in the present invention is made of a dimensionally stable metal composed primarily of aluminum; that is, aluminum or aluminum alloy. Aside from plates of pure aluminum, alloy plates composed primarily of aluminum and containing small amounts of other elements may also be used.

In the present specification, various supports made of aluminum or aluminum alloy as described above are referred to generically as “aluminum plate.” Other elements which may be present in the aluminum alloy include silicon, iron, copper, manganese, magnesium, chromium, zinc, bismuth, nickel and titanium. The content of other elements in the alloy is not more than 10 wt %.

Aluminum plates that may be used in the present invention are not specified as to composition, but include known materials that appear in the 4^{th} edition of Aluminum Handbook published in 1990 by the Japan Light Metal Association, such as aluminum plates having the designations JIS A1050, JIS A1100 and JIS A1070, and manganese-containing aluminum-manganese-based aluminum plates having the designation JIS A3004 and International Alloy Designation 3103A. Aluminum-magnesium alloys and aluminum-manganese-magnesium alloys (JIS A3005) composed of the above aluminum alloys to which at least 0.1 wt % of magnesium has been added may also be used to increase the tensile strength. Aluminum-zirconium alloys and aluminum-silicon alloys which additionally contain zirconium and silicon, respectively may also be used. Use may also be made of aluminum-magnesium-silicon alloys.

JIS 1050 materials are mentioned in JP 59-153861 A (the term “JP ______ A” as used herein means an “unexamined Japanese patent publication”), JP 61-51395 A, JP 62-146694 A, JP 60-215725 A, JP 60-215726 A, JP 60-215727 A, JP 60-216728 A, JP 61-272367 A, JP 58-11759 A, JP 58-42493 A, JP 58-221254 A, JP 62-148295 A, JP 4-254545 A, JP 4-165041 A, JP 3-68939 B (the term “JP ______ B” as used herein means an “examined Japanese patent publication”), JP 3-234594 A, JP 1-47545 B, JP 62-140894 A, JP 1-35910 B and JP 55-28874 B.

JIS 1070 materials are mentioned in JP 7-81264 A, JP 7-305133 A, JP 8-49034 A, JP 8-73974 A, JP 8-108659 A and JP 8-92679 A.

Aluminum-magnesium alloys are mentioned in JP 62-5080 B, JP 63-60823 B, JP 3-61753 B, JP 60-203496 A, JP 60-203497 A, JP 3-11635 B, JP 61-274993 A, JP 62-23794 A, JP 63-47347 A, JP 63-47348 A, JP 63-47349 A, JP 64-1293 A, JP 63-135294 A, JP 63-87288 A, JP 4-73392 B, JP 7-100844 B, JP 62-149856 A, JP 4-73394 B, JP 62-181191 A, JP 5-76530 B, JP 63-30294 A, JP 6-37116 B, JP 2-215599 A and JP 61-201747 A.

Aluminum-manganese alloys are mentioned in JP 60-230951 A, JP 1-306288 A, JP 2-293189 A, JP 54-42284 B, JP 4-19290 B, 4-19291 B, JP 4-19292 B, JP 61-35995 A, JP 64-51992 A, JP 4-226394 A, U.S. Pat. No. 5,009,722 and U.S. Pat. No. 5,028,276.

Aluminum-manganese-magnesium alloys are mentioned in JP 62-86143 A, JP 3-222796 A, JP 63-60824 B, JP 60-63346 A, JP 60-63347 A, JP 1-293350 A, EP 223,737 B, U.S. Pat. No. 4,818,300 and GB 1,222,777.

Aluminum-zirconium alloys are mentioned in JP 63-15978 B, JP 61-51395 A, JP 63-143234 A and JP 63-143235 A.

Aluminum-magnesium-silicon alloys are mentioned in GB 1,421,710.

The aluminum alloy may be formed into a plate by, for example, the method described below. First, an aluminum alloy melt that has been adjusted to a given alloying ingredient content is subjected to cleaning treatment by an ordinary method, then is cast. Cleaning treatment, which is carried out to remove hydrogen and other unnecessary gases from the melt, typically involves flux treatment; degassing treatment using argon gas, chlorine gas or the like; filtering treatment using, for example, what is referred to as a rigid media filter (e.g., ceramic tube filters, ceramic foam filters), a filter that employs a filter medium such as alumina flakes or alumina balls, or a glass cloth filter; or a combination of degassing treatment and filtering treatment.

Cleaning treatment is preferably carried out to prevent defects due to foreign matter such as nonmetallic inclusions and oxides in the melt, and defects due to dissolved gases in the melt. The filtration of melts is described in, for example, JP 6-57432 A, JP 3-162530 A, JP 5-140659 A, JP 4-231425 A, JP 4-276031 A, JP 5-311261 A, and JP 6-136466 A. The degassing of melts is described in, for example, JP 5-51659 A and JP 5-49148 U (the term “JP ______ U” as used herein means an “unexamined published Japanese utility model application”). The present applicant also proposes related technology concerning the degassing of melts in JP 7-40017 A.

Next, the melt that has been subjected to cleaning treatment as described above is cast. Casting processes include those which use a stationary mold, such as direct chill casting, and those which use a moving mold, such as continuous casting.

In direct chill casting, the melt is solidified at a cooling speed of 0.5 to 30° C. per second. At less than 1° C./s, many coarse intermetallic compounds may be formed. When direct chill casting is carried out, an ingot having a thickness of 300 to 800 mm can be obtained. If necessary, this ingot is scalped by a conventional method, generally removing 1 to 30 mm, and preferably 1 to 10 mm, of material from the surface. The ingot may also be optionally soaked, either before or after scalping. In cases where soaking is carried out, the ingot is heat treated at 450 to 620° C. for 1 to 48 hours to prevent the coarsening of intermetallic compounds. The effects of soaking treatment may be inadequate if heat treatment time is shorter than one hour.

The ingot is then hot-rolled and cold-rolled, giving a rolled aluminum plate. A temperature of 350 to 500° C. at the start of hot rolling is appropriate. Intermediate annealing may be carried out before or after hot rolling, or even during hot rolling. The intermediate annealing conditions may consist of 2 to 20 hours of heating at 280 to 600° C., and preferably 2 to 10 hours of heating at 350 to 500° C., in a batch-type annealing furnace, or of heating for up to 6 minutes at 400 to 600° C., and preferably up to 2 minutes at 450 to 550° C., in a continuous annealing furnace. Using a continuous annealing furnace to heat the rolled plate at a temperature rise rate of 10 to 200° C./s enables a finer crystal structure to be achieved.

The aluminum plate that has been finished by the above step to a given thickness of, say, 0.1 to 0.5 mm may then be flattened with a leveling machine such as a roller leveler or a tension leveler. Flattening may be carried out after the aluminum plate has been cut into discrete sheets. However, to enhance productivity, it is preferable to carry out such flattening with the rolled aluminum in the state of a continuous coil. The plate may also be passed through a slitter line to cut it to a predetermined width. A thin film of oil may be provided on the surface of the aluminum plate to prevent scuffing due to rubbing between adjoining aluminum plates. Suitable use may be made of either a volatile or non-volatile oil film, as needed.

Continuous casting processes that are industrially carried out include processes which use cooling rolls, such as the twin roll process (Hunter process) and the 3C process; and processes which use a cooling belt or a cooling block, such as the twin belt process (Hazelett process) and the Alusuisse Caster II process. When a continuous casting process is used, the melt is solidified at a cooling rate of 100 to 1,000° C./s. Continuous casting processes generally have a faster cooling rate than direct chill casting processes, and so are characterized by the ability to achieve a higher solid solubility of alloying ingredients in the aluminum matrix. Technology relating to continuous casting processes that has been proposed by the present applicant is described in, for example, JP 3-79798 A, JP 5-201166 A, JP 5-156414 A, JP 6-262203 A, JP 6-122949 A, JP 6-210406 A and JP 6-26308 A.

When continuous casting is carried out, such as by a process involving the use of cooling rolls (e.g., the Hunter process), the melt can be directly and continuously cast as a plate having a thickness of 1 to 10 mm, thus making it possible to omit the hot rolling step. Moreover, when use is made of a process that employs a cooling belt (e.g., the Hazelett process), a plate having a thickness of 10 to 50 mm can be cast. Generally, by positioning a hot-rolling roll immediately downstream of the casting section, the cast plate can then be successively rolled, enabling a continuously cast and rolled plate with a thickness of 1 to 10 mm to be obtained.

These continuously cast and rolled plates are then subjected to such processes as cold rolling, intermediate annealing, flattening and slitting in the same way as described above for direct chill casting, and thereby finished to a plate thickness of 0.1 to 0.5 mm, for instance. Technology proposed by the present applicant concerning the intermediate annealing conditions and cold rolling conditions in a continuous casting process is described in, for example, JP 6-220593 A, JP 6-210308 A, JP 7-54111 A and JP 8-92709 A.

Because the crystal structure at the surface of the aluminum plate may give rise to a poor surface quality when chemical graining treatment or electrochemical graining treatment is carried out, it is preferable that the crystal structure not be too coarse. The crystal structure at the surface of the aluminum plate has a width of preferably up to 200 μm, more preferably up to 100 μm, and most preferably up to 50 μm. Moreover, the crystal structure has a length of preferably up to 5,000 μm, more preferably up to 1,000 μm, and most preferably up to 500 μm. Related technology proposed by the present applicant is described in, for example, JP 6-218495 A, JP 7-39906 A and JP 7-124609 A.

It is preferable for the alloying ingredient distribution at the surface of the aluminum plate to be reasonably uniform because non-uniform distribution of alloying ingredients at the surface of the aluminum plate sometimes leads to a poor surface quality when chemical graining treatment or electrochemical graining treatment is carried out. Related technology proposed by the present applicant is described in, for example, JP 6-48058 A, JP 5-301478 A and JP 7-132689 A.

The size or density of intermetallic compounds in an aluminum plate may affect chemical graining treatment or electrochemical graining treatment. Related technology proposed by the present applicant is described in, for example, JP 7-138687 A and JP 4-254545 A.

In the present invention, the aluminum plate as described above may be used after a pattern of recesses and protrusions has been formed on the aluminum plate in the final rolling process or the like by pack rolling, transfer or another method.

The aluminum plate that may be used in the present invention may be in the form of an aluminum web or a cut sheet.

When the aluminum plate is in the form of a web, it may be packed by, for example, laying hardboard and felt on an iron pallet, placing corrugated cardboard doughnuts on either side of the product, wrapping everything with polytubing, inserting a wooden doughnut into the opening at the center of the coil, stuffing felt around the periphery of the coil, tightening steel strapping about the entire package, and labeling the exterior. In addition, polyethylene film can be used as the outer wrapping material, and needled felt and hardboard can be used as the cushioning material. Various other forms of packing exist, any of which may be used so long as the aluminum plate can be stably transported without being scratched or otherwise marked.

The aluminum plate that may be used in the present invention preferably has a thickness of about 0.1 to about 0.6 mm, more preferably 0.15 to 0.4 mm, and even more preferably 0.2 to 0.3 mm. This thickness can be changed as appropriate according to the desires of the user.

### <Surface Treatment>

The surface treatments performed during the production of the porous alumina support include surface graining treatment and anodizing treatment. Various other steps than surface graining treatment and anodizing treatment may also be included in the process of producing the porous alumina support.

Typical methods of forming the surface profile described above include a method in which an aluminum plate is subjected to mechanical graining treatment, alkali etching treatment, desmutting treatment with an acid and electrochemical graining treatment with an electrolytic solution in this order; a method in which an aluminum plate is subjected to mechanical graining treatment, and two or more cycles of alkali etching treatment, desmutting treatment with an acid and electrochemical graining treatment (different electrolytic solutions are used in the respective cycles); a method in which an aluminum plate is subjected to alkali etching treatment, desmutting treatment with an acid, and electrochemical graining treatment with an electrolytic solution in this order; and a method in which an aluminum plate is subjected to two or more cycles of alkali etching treatment, desmutting treatment with an acid and electrochemical graining treatment (different electrolytic solutions are used in the respective cycles). However, the present invention is not limited thereto. In these methods, electrochemical graining treatment may be further followed by alkali etching treatment and desmutting treatment with an acid.

Although the method applied depends on the conditions of the other treatments (including alkali etching treatment), a method in which mechanical graining treatment, electrochemical graining treatment using a nitric acid-based electrolytic solution, and electrochemical graining treatment using a hydrochloric acid-based electrolytic solution are performed in this order is preferably used to form a surface profile in which the small-wave structure is superimposed on the medium-wave structure, which in turn is superimposed on the large-wave structure. In order to form a surface profile in which the small-wave structure is superimposed on the large-wave structure, a method is preferably used in which electrochemical graining treatment using a hydrochloric acid-based electrolytic solution is only performed with an increased total amount of electricity furnished to the anodic reaction.

The respective surface treatment steps will be described below in detail.

### <Mechanical Graining Treatment>

Mechanical graining treatment is less expensive than electrochemical graining and can form a surface having irregularities with an average wavelength of 5 to 100 μm. It is thus effective as a graining means for forming the large-wave structure.

Examples of mechanical graining treatment include wire brush graining in which the aluminum surface is scratched with metal wire, ball graining in which the aluminum surface is grained with abrasive balls and an abrasive, and brush graining described in JP 6-135175 A and JP 50-40047 B in which the surface is grained with a nylon brush and an abrasive.

It is also possible to use a transfer roll method in which a surface having recesses and protrusions is pressed against the aluminum plate. Specific examples of the method that may be employed include the methods described in JP 55-74898 A, JP 60-36195 A and JP 60-203496 A, the method described in JP 6-55871 A which is characterized by carrying out transfer a plurality of times, and the method described in JP 6-24168 A which is characterized in that the surface has elasticity.

Other methods that may be used include a method in which transfer is repeatedly carried out using a transfer roll in which fine recesses and protrusions have been formed by, for example, electrodischarge machining, shot blasting, laser machining or plasma etching; and a method in which a textured surface (surface having recesses and protrusions) coated with fine particles is placed against the aluminum plate, pressure is repeatedly applied from above the textured surface a plurality of times, and a textured pattern corresponding to the average diameter of the fine particles is repeatedly transferred to the aluminum plate. Known methods such as those described in JP 3-8635 A, JP 3-66404 A and JP 63-65017 A may be used to impart a fine texture to the transfer roll. Alternatively, angular recesses and protrusions may be applied to the roll surface by forming fine grooves in the roll surface in two directions with, for example, a die, a cutting tool or a laser. The resulting roll surface may be subjected to a known etching treatment to round somewhat the angular recesses and protrusions thus formed.

A process such as quenching or hard chromium plating may also be carried out to increase the surface hardness.

In addition, use may also be made of the mechanical graining treatments described in, for example, JP 61-162351 A and JP 63-104889 A.

In the practice of the present invention, the methods mentioned above may be used in combination while taking into account productivity and other factors. It is preferable for these mechanical graining treatments to be carried out prior to electrochemical graining treatment.

The brush graining process, which may be suitably used as the mechanical graining treatment, is described below in detail. The brush graining process is generally a method in which a brush roller composed of a round cylinder on the surface of which are set numerous bristles, typically made of a synthetic resin such as nylon (trademark), polypropylene or polyvinyl chloride is used to rub one or both sides of the aluminum plate while an abrasive-containing slurry is sprayed onto the rotating brush roller. A polishing roller having a polishing layer formed on its surface may be used instead of the aforementioned brush roller and slurry. When a brush roller is used, the bristles on the brush have a flexural modulus of preferably 10,000 to 40,000 kgf/cm², and more preferably 15,000 to 35,000 kgf/cm², and a stiffness of preferably 500 gf or less, and more preferably 400 gf or less. The bristle diameter is generally 0.2 to 0.9 mm. The bristle length can be suitably selected in accordance with the outside diameter of the brush roller and the cylinder diameter, but is generally from 10 to 100 mm.

A known abrasive may be used. Illustrative examples include pumice stone, silica sand, aluminum hydroxide, alumina powder, silicon carbide, silicon nitride, volcanic ash, carborundum, emery, and mixtures thereof. Of these, pumice stone and silica sand are preferred. Silica sand is especially preferred because it is harder than pumice stone and breaks less readily, and thus has an excellent graining efficiency. To provide an excellent graining efficiency and reduce the pitch of the grained pattern, it is desirable for the abrasive to have an average particle size of preferably 3 to 50 μm, and more preferably 6 to 45 μm. The abrasive is typically suspended in water and used as a slurry. In addition to the abrasive, the slurry may also include such additives as a thickener, a dispersant (e.g., a surfactant), and a preservative. The slurry has a specific gravity in a range of preferably 0.5 to 2.

An example of an apparatus suitable for mechanical graining treatment is that described in JP 50-40047 B.

### <Electrochemical Graining Treatment>

Electrochemical graining treatment (also referred to below as “electrolytic graining treatment”) may be carried out with an electrolytic solution of the type employed in conventional electrochemical graining treatment using an alternating current. In particular, the use of an electrolytic solution containing primarily hydrochloric acid or nitric acid enables the surface profile as described above to be readily obtained and is therefore preferable.

The electrolytic graining treatment may be carried out in accordance with, for example, the electrochemical graining process (electrolytic graining process) described in JP 48-28123 B and GB 896,563. A sinusoidal alternating current is used in the electrolytic graining process but special waveforms described in JP 52-58602 A may also be used. Use may also be made of the waveforms described in JP 3-79799 A. Other processes that may be employed for this purpose include those described in JP 55-158298 A, JP 56-28898 A, JP 52-58602 A, JP 52-152302 A, JP 54-85802 A, JP 60-190392 A, JP 58-120531 A, JP 63-176187 A, JP 1-5889 A, JP 1-280590 A, JP 1-118489 A, JP 1-148592 A, JP 1-178496 A, JP 1-188315 A, JP 1-154797 A, JP 2-235794 A, JP 3-260100 A, JP 3-253600 A, JP 4-72079 A, JP 4-72098 A, JP 3-267400 A and JP 1-141094 A. In addition to the above, electrolytic graining treatment may also be carried out using alternating currents of special frequency such as have been proposed in connection with methods for manufacturing electrolytic capacitors. These are described in, for example, U.S. Pat. No. 4,276,129 and U.S. Pat. No. 4,676,879.

Various electrolytic cells and power supplies have been proposed for use in electrochemical graining treatment. For example, use may be made of those described in U.S. Pat. No. 4,203,637, JP 56-123400 A, JP 57-59770 A, JP 53-12738 A, JP 53-32821 A, JP 53-32822 A, JP 53-32823 A, JP 55-122896 A, JP 55-132884 A, JP 62-127500 A, JP 1-52100 A, JP 1-52098 A, JP 60-67700 A, JP 1-230800 A, JP 3-257199 A, JP 52-58602 A, JP 52-152302 A, JP 53-12738 A, JP 53-12739 A, JP 53-32821 A, JP 53-32822 A, JP 53-32833 A, JP 53-32824 A, JP 53-32825 A, JP 54-85802 A, JP 55-122896 A, JP 55-132884 A, JP 48-28123 B, JP 51-7081 B, JP 52-133838 A, JP 52-133840 A, JP 52-133844 A, JP 52-133845 A, JP 53-149135 A and JP 54-146234 A.

In addition to nitric acid and hydrochloric acid solutions, other acidic solutions that may be used for the electrolytic solution include the electrolytic solutions mentioned in U.S. Pat. No. 4,671,859, U.S. Pat. No. 4,661,219, U.S. Pat. No. 4,618,405, U.S. Pat. No. 4,600,482, U.S. Pat. No. 4,566,960, U.S. Pat. No. 4,566,958, U.S. Pat. No. 4,566,959, U.S. Pat. No. 4,416,972, U.S. Pat. No. 4,374,710, U.S. Pat. No. 4,336,113 and U.S. Pat. No. 4,184,932.

The acidic solution has a concentration of preferably 0.5 to 2.5 wt %, although a concentration of 0.7 to 2.0 wt % is especially preferred for use in desmutting treatment mentioned above. The electrolytic solution preferably has a temperature of 20 to 80° C. and more preferably 30 to 60° C.

The aqueous solution composed primarily of hydrochloric acid or nitric acid may be obtained by dissolving a nitrate ion-containing compound such as aluminum nitrate, sodium nitrate or ammonium nitrate or a chloride ion-containing compound such as aluminum chloride, sodium chloride or ammonium chloride to a concentration of from 1 g/L to saturation in a 1 to 100 g/L solution of hydrochloric acid or nitric acid in water. Metals which are present in the aluminum alloy, such as iron, copper, manganese, nickel, titanium, magnesium and silicon may be dissolved in the aqueous solution composed primarily of hydrochloric acid or nitric acid. It is preferable to use a solution prepared by dissolving a compound such as aluminum chloride or aluminum nitrate to an aluminum ion concentration of 3 to 50 g/L in a 0.5 to 2 wt % solution of hydrochloric acid or nitric acid in water.

By adding and using a compound capable of forming a complex with copper, uniform graining may be carried out even on an aluminum plate having a high copper content. Examples of the compound capable of forming a complex with copper include ammonia; amines obtained by substituting the hydrogen atom on ammonia with a hydrocarbon group (of an aliphatic, aromatic, or other nature), such as methylamine, ethylamine, dimethylamine, diethylamine, trimethylamine, cyclohexylamine, triethanolamine, triisopropanolamine and ethylenediamine tetraacetate (EDTA); and metal carbonates such as sodium carbonate, potassium carbonate and potassium hydrogencarbonate. Additional compounds suitable for this purpose include ammonium salts such as ammonium nitrate, ammonium chloride, ammonium sulfate, ammonium phosphate and ammonium carbonate. The temperature of the aqueous solution is preferably in a range of 10 to 60° C. and more preferably 20 to 500° C.

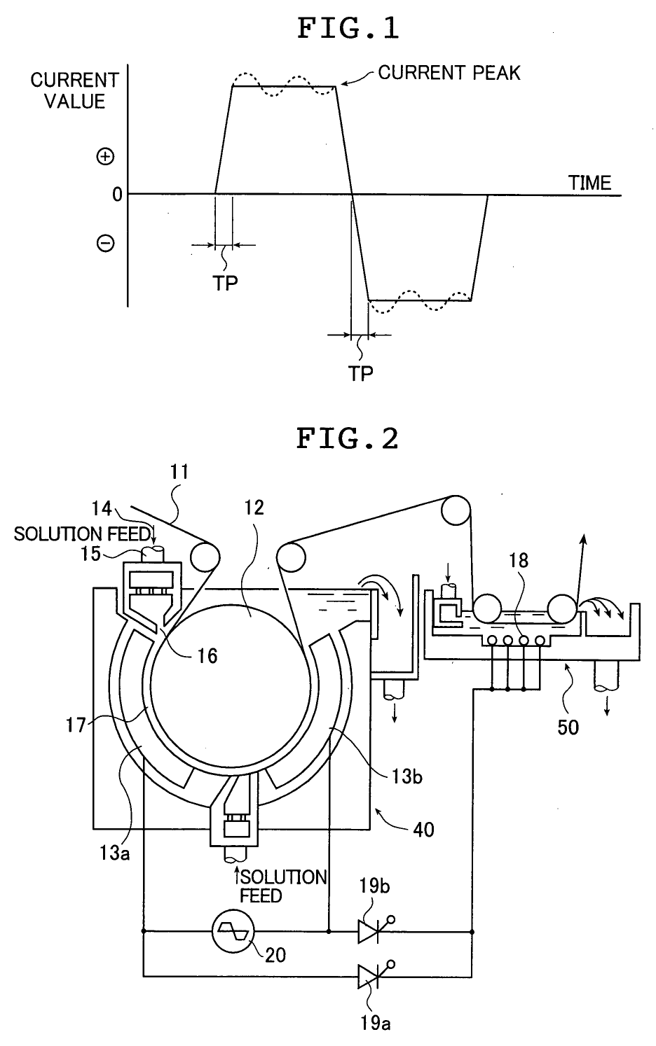

No particular limitation is imposed on the alternating current waveform used in electrochemical graining treatment. For example, a sinusoidal, square, trapezoidal or triangular waveform may be used, but a square or trapezoidal waveform is preferred and a trapezoidal waveform is particularly preferred. “Trapezoidal waveform” refers herein to such a waveform as shown in FIG. 1. In the trapezoidal waveform, the time TP in which the current value changes from zero to a peak is preferably 1 to 3 ms. If the time is less than 1 ms, treatment unevenness called “chatter mark” may readily occur perpendicularly to the direction of movement of the aluminum plate. If the time TP exceeds 3 ms, the process tends to be affected by trace ingredients in the electrolytic solution as typified by ammonium ions that spontaneously increase during electrolytic treatment, making it difficult to carry out uniform graining.

Alternating current having a trapezoidal waveform and a duty ratio of 1:2 to 2:1 may be used. However, as noted in JP 5-195300 A, in an indirect power feed system that does not use a conductor roll to feed current to the aluminum, a duty ratio of 1:1 is preferred. Alternating current having a trapezoidal waveform and a frequency of 0.1 to 120 Hz may be used, although a frequency of 50 to 70 Hz is preferable from the standpoint of the equipment. At a frequency lower than 50 Hz, the carbon electrode serving as the main electrode tends to dissolve more readily. On the other hand, at a frequency higher than 70 Hz, the power supply circuit is more readily subject to the influence of inductance thereon. The result in both of these cases is an increase in the power supply costs.

One or more AC power supplies may be connected to the electrolytic cell. To control the anode/cathode current ratio of the alternating current applied to the aluminum plate opposite to the main electrodes and thereby carry out uniform graining and to dissolve carbon from the main electrodes, it is advantageous to provide an auxiliary anode and divert part of the alternating current as shown in FIG. 2. FIG. 2 shows an aluminum plate 11, a radial drum roller 12, main electrodes 13a and 13b, an electrolytic treatment solution 14, a solution feed inlet 15, a slit 16, a solution channel 17, auxiliary anodes 18, thyristors 19a and 19b, an AC power supply 20, a main electrolytic cell 40 and an auxiliary anode cell 50. By using a rectifying or switching device to divert part of the current as direct current to the auxiliary anodes provided in the separate cell from that containing the two main electrodes, it is possible to control the ratio between the current value furnished to the anodic reaction which acts on the aluminum plate opposite to the main electrodes and the current value furnished to the cathodic reaction. The ratio between the amount of electricity furnished to the cathodic reaction and the amount of electricity furnished to the anodic reaction on the aluminum plate opposite to the main electrodes (ratio of the amount of electricity when the aluminum plate serves as an cathode to that when the aluminum plate serves as an anode) is preferably 0.3 to 0.95.

Any known electrolytic cell employed for surface treatment, including vertical, flat and radial type electrolytic cells, may be used to carry out electrochemical graining treatment. Radial-type electrolytic cells such as those described in JP 5-195300 A are especially preferred. The electrolytic solution is passed through the electrolytic cell either parallel or counter to the direction in which the aluminum web advances.

### (Nitric Acid Electrolysis)

Irregularities having an average wavelength of 0.5 to 5 μm can be formed by electrochemical graining treatment using an electrolytic solution composed primarily of nitric acid. When the amount of electricity is made relatively large, the electrolytic reaction concentrates, resulting in the formation of irregularities having a wavelength larger than 5 μm as well.

To obtain such a surface profile, the total amount of electricity furnished to the anodic reaction on the aluminum plate up until completion of the electrolytic reaction is preferably 1 to 1,000 C/dm², and more preferably 50 to 300 C/dm². The current density at this time is preferably 20 to 100 A/dm².

A small-wave structure having an average wavelength of 0.20 μm or less may also be formed by performing electrolysis at a temperature of 30 to 60° C. with a high-concentration electrolytic solution of nitric acid having a nitric acid concentration of 15 to 35 wt %, or by performing electrolysis at a high temperature (e.g., 80° C. or higher) with an electrolytic solution of nitric acid having a nitric acid concentration of 0.7 to 2 wt %. As a result, ΔS can have a larger value.

### (Hydrochloric Acid Electrolysis)

Hydrochloric acid by itself has a strong ability to dissolve aluminum, and fine irregularities can be formed on the surface with the application of just a slight degree of electrolysis. These fine irregularities have an average wavelength of 0.01 to 0.2 μm, and arise uniformly over the entire surface of the aluminum plate.

To obtain such a surface profile, the total amount of electricity furnished to the anodic reaction on the aluminum plate up until completion of the electrolytic reaction is preferably 1 to 100 C/dm², and more preferably 20 to 70 C/dm². The current density at this time is preferably 20 to 50 A/dm².

In such electrochemical graining treatment with an electrolytic solution composed primarily of hydrochloric acid, by furnishing a large total amount of electricity of 400 to 2,000 C/dm² to the anodic reaction, large crater-like undulations can also be formed at the same time. Under these conditions, fine irregularities having an average wavelength of 0.01 to 0.4 μm are formed on the entire surface so that they are superimposed on crater-like undulations having an average wavelength of 10 to 30 μm. In this case, the medium-wave structure having an average wavelength of 0.5 to 5 μm is not formed.

It is effective to form a multiplicity of small irregularities on the surface in order to have a larger ΔS value. Methods that may be appropriately used to form a multiplicity of small irregularities on the surface as described above include electrolytic graining treatment using an electrolytic solution composed primarily of hydrochloric acid, and electrolytic graining treatment using a high-concentration and high-temperature electrolytic solution composed primarily of nitric acid. The difference in surface area ΔS may take a large value through mechanical graining treatment or commonly performed electrolytic graining treatment using an electrolytic solution composed primarily of nitric acid, but is only increased to a smaller degree than in the above methods.

It is preferable for the aluminum plate to be subjected to cathodic electrolysis before and/or after electrolytic graining treatment in the nitric acid- or hydrochloric acid-containing electrolytic solution as described above. Such cathodic electrolysis gives rise to smut formation on the surface of the aluminum plate and hydrogen gas evolution, which enables uniform electrolytic graining treatment to be achieved.

Cathodic electrolysis is carried out in an acidic solution in an amount of electricity applied to the cathode of preferably 3 to 80 C/dm², and more preferably 5 to 30 C/dm². At less than 3 C/dm² of electricity, the amount of smut deposition may be inadequate, whereas at more than 80 C/dm², the amount of smut deposition may be excessive. The electrolytic solution may be the same as or different from the one used in electrolytic graining treatment.

### <Alkali Etching Treatment>

Alkali etching is a treatment in which the surface layer of the above-described aluminum plate is brought into contact with an alkali solution and dissolved.

When mechanical graining treatment has not been carried out, the purpose of carrying out alkali etching treatment prior to electrolytic graining treatment is to remove substances such as rolling oils, contaminants and a natural oxide film from the surface of the aluminum plate (rolled aluminum). When mechanical graining treatment has already been carried out, the purpose of such alkali etching treatment is to dissolve the edge areas of pits formed by mechanical graining treatment so as to transform the surface having the pits with sharp edges into a smoothly undulating surface.

If mechanical graining treatment is not carried out prior to alkali etching treatment, the amount of etching is preferably 0.1 to 10 g/m², and more preferably 1 to 5 g/m². At less than 0.1 g/m², substances such as rolling oils, contaminants and a natural oxide film may remain on the surface, which may make it impossible for uniform pits to be formed in subsequent electrolytic graining treatment, and may thus give rise to surface unevenness. On the other hand, at an etching amount of 1 to 10 g/m², the sufficient removal of substances such as rolling oils, contaminants and a natural oxide film will take place. An etching amount exceeding the above range is economically undesirable.

If mechanical graining treatment is carried out prior to alkali etching treatment, the amount of etching is preferably 3 to 20 g/m² and more preferably 5 to 15 g/m². At an etching amount of less than 3 g/m², it may not be possible to smoothen the irregularities formed by treatment such as mechanical graining treatment, as a result of which uniform pit formation may be impossible to achieve in subsequent electrolytic graining treatment. On the other hand, at an etching amount of more than 20 g/m², the surface structure of recesses and protrusions may vanish.

The purpose of carrying out alkali etching treatment immediately after electrolytic graining treatment is to dissolve smut that has formed in the acidic electrolytic solution and to dissolve the edge areas of pits that have been formed by electrolytic graining treatment. The pits that are formed by electrolytic graining treatment vary depending on the type of electrolytic solution used, so the optimal amount of etching also varies. However, the amount of etching in alkali etching treatment carried out after electrolytic graining treatment is preferably 0.1 to 5 g/m². When a nitric acid electrolytic solution is used, it is necessary to set the amount of etching somewhat larger than that when a hydrochloric acid electrolytic solution is used. If electrolytic graining treatment is carried out a plurality of times, alkali etching may be carried out as needed after each electrolytic graining treatment.

Alkalis that may be used in the alkali solution are exemplified by caustic alkalis and alkali metal salts. Specific examples of suitable caustic alkalis include sodium hydroxide and potassium hydroxide. Specific examples of suitable alkali metal salts include alkali metal silicates such as sodium metasilicate, sodium silicate, potassium metasilicate and potassium silicate; alkali metal carbonates such as sodium carbonate and potassium carbonate; alkali metal aluminates such as sodium aluminate and potassium aluminate; alkali metal aldonates such as sodium gluconate and potassium gluconate; and alkali metal hydrogenphosphates such as sodium secondary phosphate, potassium secondary phosphate, sodium primary phosphate and potassium primary phosphate. Of these, caustic alkali solutions and solutions containing both a caustic alkali and an alkali metal aluminate are preferred on account of the high etch rate and low cost. An aqueous solution of sodium hydroxide is especially preferred.

The concentration of the alkali solution may be set in accordance with the desired amount of etching, and is preferably 1 to 50 wt %, and more preferably 10 to 35 wt %. When aluminum ions are dissolved in the alkali solution, the concentration of the aluminum ions is preferably 0.01 to 10 wt %, and more preferably 3 to 8 wt %. It is preferable for the alkali solution to have a temperature of 20 to 90° C., and for the treatment time to be from 1 to 120 seconds.

Illustrative examples of methods for bringing the aluminum plate into contact with the alkali solution include a method in which the aluminum plate is passed through a tank filled with an alkali solution, a method in which the aluminum plate is immersed in a tank filled with an alkali solution, and a method in which the surface of the aluminum plate is sprayed with an alkali solution.

### <Desmutting Treatment>

After electrolytic graining treatment or alkali etching treatment, it is preferable to carry out acid pickling (desmutting treatment) to remove contaminants (smut) remaining on the surface of the aluminum plate.

Examples of acids that may be used include nitric acid, sulfuric acid, phosphoric acid, chromic acid, hydrofluoric acid and tetrafluoroboric acid. Desmutting treatment is carried out by bringing the aluminum plate into contact with an acidic solution of, for example, hydrochloric acid, nitric acid or sulfuric acid having an acid concentration of 0.5 to 30 wt % and an aluminum ion concentration of 0.01 to 5 wt %. Exemplary methods for bringing the aluminum plate into contact with the acidic solution include passing the aluminum plate through a tank filled with the acidic solution, immersing the aluminum plate in a tank filled with the acidic solution, and spraying the acidic solution onto the surface of the aluminum plate. The acidic solution used in desmutting treatment may be the aqueous solution composed primarily of nitric acid or the aqueous solution composed primarily of hydrochloric acid that is discharged as wastewater from the above-described electrolytic graining treatment, or the aqueous solution composed primarily of sulfuric acid that is discharged as wastewater from the subsequently described anodizing treatment. The solution temperature in desmutting treatment is preferably 25 to 90° C., and the treatment time is preferably 1 to 180 seconds. The acidic solution used in desmutting treatment may include aluminum and aluminum alloy components dissolved therein.

### <Anodizing Treatment>

The aluminum plate treated as described above is also subjected to anodizing treatment. A porous alumina layer (anodized layer) having a multiplicity of pits called pores (micropores) is formed on the surface of the aluminum plate through anodizing treatment, whereby a porous alumina support is obtained.

Anodizing treatment can be carried out by a commonly used method. More specifically, an anodized layer can be formed on the surface of the aluminum plate by passing a current through the aluminum plate as the anode in, for example, a solution having a sulfuric acid concentration of 50 to 300 g/L and an aluminum ion concentration of up to 5 wt %. The solution used for anodizing treatment includes any one or combination of two or more of, for example, sulfuric acid, phosphoric acid, chromic acid, oxalic acid, sulfamic acid, benzenesulfonic acid and amidosulfonic acid.

It is acceptable for ingredients ordinarily present in at least the aluminum plate, electrodes, tap water, ground water and the like to be present in the electrolytic solution. In addition, secondary and tertiary ingredients may be added. Here, “secondary and tertiary ingredients” includes, for example, the ions of metals such as sodium, potassium, magnesium, lithium, calcium, titanium, aluminum, vanadium, chromium, manganese, iron, cobalt, nickel, copper and zinc; cations such as ammonium ions; and anions such as nitrate ions, carbonate ions, chloride ions, phosphate ions, fluoride ions, sulfite ions, titanate ions, silicate ions and borate ions. These may be present in a concentration of about 0 to 10,000 ppm.

The anodizing treatment conditions vary depending on the electrolytic solution used, and thus cannot be strictly specified. However, it is generally suitable for the solution to have an electrolyte concentration of 1 to 80 wt % and a temperature of 5 to 70° C., and for the current density to be 0.5 to 60 A/dm², the voltage to be 1 to 100 V, and the electrolysis time to be 15 seconds to 50 minutes. These conditions may be adjusted to obtain the desired anodized layer weight.

Methods that may be used to carry out anodizing treatment include those described in JP 54-81133 A, JP 57-47894 A, JP 57-51289 A, JP 57-51290 A, JP 57-54300 A, JP 57-136596 A, JP 58-107498 A, JP 60-200256 A, JP 62-136596 A, JP 63-176494 A, JP 4-176897 A, JP 4-280997 A, JP 6-207299 A, JP 5-24377 A, JP 5-32083 A, JP 5-125597 A and JP 5-195291 A.

Of these, as described in JP 54-12853 A and JP 48-45303 A, it is preferable to use a sulfuric acid solution as the electrolytic solution. The electrolytic solution has a sulfuric acid concentration of preferably 10 to 300 g/L, and an aluminum ion concentration of preferably 1 to 25 g/L and more preferably 2 to 10 g/L. Such an electrolytic solution can be prepared by adding a compound such as aluminum sulfate to dilute sulfuric acid having a sulfuric acid concentration of 50 to 200 g/L.

When anodizing treatment is carried out in an electrolytic solution containing sulfuric acid, direct current or alternating current may be applied across the aluminum plate and the counter electrode. When a direct current is applied to the aluminum plate, the current density is preferably 1 to 60 A/dm² and more preferably 5 to 40 A/dm². To keep burnt deposits (areas of the anodized layer which are thicker than surrounding areas) from arising on portions of the aluminum plate due to the concentration of current when anodizing treatment is carried out as a continuous process, it is preferable to apply current at a low density of 5 to 10 A/dm² at the start of anodizing treatment and to increase the current density to 30 to 50 A/dm² or more as anodizing treatment proceeds. When anodizing treatment is carried out as a continuous process, this is preferably done using a system that supplies power to the aluminum plate through the electrolytic solution.

The micropores in the anodized layer generally have an average diameter of about 5 to 50 nm and an average pore density of about 300 to 800 pores/μm².

The weight of the anodized layer is preferably 1 to 5 g/m². At a weight of less than 1 g/m², scratches are readily formed on the porous alumina support according to the present invention. A weight in excess of 5 g/m² requires a large amount of electric power, which is economically disadvantageous. An anodized layer weight of 1.5 to 4 g/m² is more preferred. It is also desirable for anodizing treatment to be carried out in such a way that the difference in the anodized layer weight between the center of the aluminum plate and the areas near the edges is not more than 1 g/m².

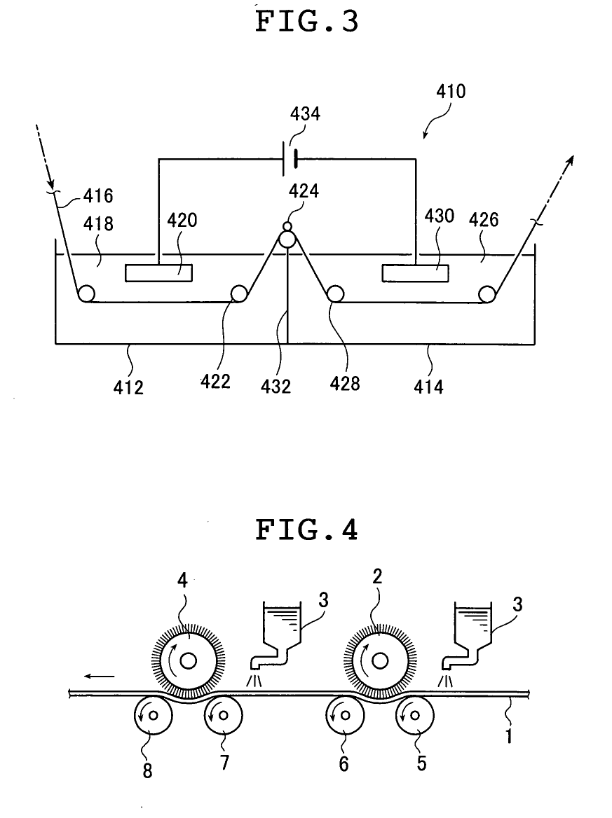

Examples of electrolysis apparatuses that may be used in anodizing treatment include those described in JP 48-26638 A, JP 47-18739 A and JP 58-24517 B. Of these, an apparatus like that shown in FIG. 3 is preferred. FIG. 3 is a schematic view showing an exemplary apparatus for anodizing the surface of an aluminum plate. In an anodizing apparatus 410, an aluminum plate 416 is transported as shown by arrows in FIG. 3. The aluminum plate 416 is charged positive (+) by a power supply electrode 420 in a power supply cell 412 containing an electrolytic solution 418. The aluminum plate 416 is then transported upward by a roller 422 disposed in the power supply cell 412, turned downward by a nip roller 424 and transported toward an electrolytic cell 414 containing an electrolytic solution 426 to be turned to a horizontal direction by a roller 428. Then, the aluminum plate 416 is charged negative (−) by an electrolytic electrode 430 to form an anodized layer on the plate surface. The aluminum plate 416 emerging from the electrolytic cell 414 is then transported to the section for the subsequent step. In the anodizing apparatus 410, the roller 422, the nip roller 424 and the roller 428 constitute direction changing means, and the aluminum plate 416 is transported through the power supply cell 412 and the electrolytic cell 414 in a mountain shape and a reversed U shape by means of these rollers 422, 424 and 428. The power supply electrode 420 and the electrolytic electrode 430 are connected to a dc power supply 434.

The characteristic feature of the anodizing apparatus 410 shown in FIG. 3 is that the aluminum plate 416 is transported in a mountain shape and a reversed U shape through the power supply cell 412 and the electrolytic cell 414 that are separated by a single cell wall 432. This configuration enables the length of the aluminum plate 416 held in the two cells to be longer. Therefore, the total length of the anodizing apparatus 410 can be shortened, thus enabling a decrease in equipment costs. Transport of the aluminum plate 416 in a mountain shape and a reversed U shape eliminates the necessity of forming an opening for passing the aluminum plate 416 through the cell wall 432 between the cells 412 and 414. The amount of electrolytic solution required for maintaining each of the liquid surfaces of the cells 412 and 414 at a necessary height can be thus suppressed to enable a decrease in running costs.

### <Sealing Treatment>

In the present invention, sealing treatment may be carried out as required to seal micropores in the anodized layer. Sealing treatment may be carried out using any known method, illustrative examples of which include boiling water treatment, hot water treatment, steam treatment, sodium silicate treatment, nitrite treatment, and ammonium acetate treatment. Sealing treatment may be carried out by using the apparatuses and methods described in, for example, JP 56-12518 B, JP 4-4194 A, JP 5-202496 A and JP 5-179482 A.

### <Rinsing Treatment>

Each of the aforementioned treatment steps is preferably followed by rinsing with water. Water that may be used in rinsing include pure water, ground water and tap water. A nipping device may also be used to prevent the treatment solution to be carried over to the next step.

### <Catalyst>

The catalyst that may be used in the present invention is not subject to any particular limitation, and specific examples of the preferable catalyst include AlCl₃ and AlBr₃ (typical catalytic reactions/uses are hereinafter indicated in parentheses; alkylation, skeletal isomerization, acylation (Friedel-Crafts rection)), Al₂O₃ (alcohol dehydration, olefin isomerization, hydrogen exchange in paraffins, support), SiO₂ (support), SiO₂—Al₂O₃ (cracking, isomerization, alkylation), zeolite (cracking, isomerization, alkylation, methanol-to-gasoline (MTG) process, support), SiO₂—NiO (ethylene dimerization), active carbon (support), PbO/Al₂O₃ (oxidative dimerization of toluene), LaCoO₃ (combustion catalyst), H₃PO₄ and H₄P₂O₇ (polymerization, isomerization, alkylation, hydration), Bi₂O₃—MoO₃ (oxidation, ammoxidation), Sb₂O₅, SbO₅—Fe₂O₃ and SnO₂—Sb₂O₅ (oxidation, ammoxidation, dehydrogenation), Cu (methanol oxidation, acrylonitrile hydration→acrylamide), Cu₂O—Cr₂O₃ (CO hydrogenation, dehydrogenation, hydrocracking (ether→alcohol)), Cu—Cr₂O₃—ZnO (acetylene+aldehyde→alkynol), Cu—ZnO (low-temperature CO shift reaction, methanol synthesis), Cu/SiO₂ (nitrobenzene→aniline), CuCl₂ (oxychlorination of ethylene), Ag/α-Al₂O₃ (ethylene→ethylene oxide, methanol→formaldehyde), ZnO (alcohol dehydration, hydrogenation), ZnO—Cr₂O₃ (methanol synthesis), ZnCl₂ (ROH+HX→RX+H₂O), ZnO—Al₂O₃—CaO (ethylbenzene dehydrogenation), TiO₂ (support), TiCl₄.Al (C₂H₅)₃ (olefin polymerization), Pt/TiO₂ (water photolysis), V₂O₅ (o-xylene, benzene, SO₂ oxidation), V₂O₅—P₂O₅ (butane oxidation→maleic anhydride), V₂O₅/TiO₂ (NOₓ reduction), Cr₂O₃ (dehydrogenation, hydrogenation), Cr₂O₃/Al₂O₃ (dehydrogenation), MoO₃ (metathesis, cyclodehydrogenation, hydrogenation, oxidation), MoO₃—SnO₂ (propylene oxidation, ammoxidation), Co.Mo/Al₂O₃ (hydrodesulfurization), Ni.Mo/Al₂O₃ (hydrodenitrogenation), MOS₂ (hydrogenation, olefin isomerization), Mo—Bi—O (isobutene oxidation→methacrolein, isobutene ammoxidation→methacrylonitrile), MoO₃—Fe₂O₃ (methanol oxidation), H₃PMo₁₂O₄₀ (olefin hydration, alcohol dehydration, dehydrogenation of isobutyric acid), WO₃ (metathesis, cyclodehydrogenation, oxidation), H₃PW₁₂O₄₀ (olefin hydration, alcohol dehydration), MnO₂ (CO oxidation, N₂O decomposition), Fe—K₂O—Al₂O₃ (ammonia synthesis, Fischer-Tropsch synthesis), Fe₂O₃—Cr₂O₃ (high-temperature CO shift reaction), Fe₂O₃—Cr₂O₃—K₂O (ethylbenzene oxidation/dehydrogenation), Fe₂O₃ (ethylbenzene oxidation/dehydrogenation, Noₓ reduction), Co (Fischer-Tropsch synthesis), cobalt/active carbon (ethylene dimerization), Co₃O₄ (oxidation), cobalt carbonyl complex (olefin hydroformylation), Ni (Raney nickel) (hydrogenation), nickel/support (hydrogenation, steam reforming, methanation), modified nickel (asymmetric hydrogenation), Pt (hydrogenation, dehydrogenation, oxidation), Pt/Al₂O₃ (petroleum reforming), Pt—Rh—Pd/support (vehicle emission gas purification), Pd (hydrogenation), Pd/SiO₂, Al₂O₃ (partial hydrogenation), PdCl₂—CuCl₂ (olefin oxidation (Wacker process)), Re (hydrogenation, oxidation), Re—Pt/Al₂O₃ (petroleum reforming), Re₂O₇/Al₂O₃ (metathesis), Ru (hydrogenation, ammonia synthesis), Ru/Al₂O₃ (methanation, Fischer-Tropsch synthesis), Rh (CO hydrogenation), rhodium complex (hydroformylation, CO hydrogenation (synthesis of oxygen-containing compound)).

Catalysts are used in applications requiring heat resistance as exemplified by vehicle emission gas purification, high-temperature CO shift reaction and dehydrogenation. Of those identified above, platinum catalysts that may be used for vehicle emission gas purification are significantly useful.

The catalyst supporting body of the present invention has any of the aforementioned catalysts supported on the aforementioned porous alumina support.

Catalysts may be supported using any known technique without particular limitation.

Examples of preferred techniques include electrodeposition, and a method which involves coating the aluminum plate having the anodized layer with a dispersion of catalyst particles, then drying. The catalyst is preferably in the form of single particles or agglomerates.

An electrodeposition method known in the art may be used. For example, in the case of gold electrodeposition, use may be made of a process in which the aluminum plate is immersed in a 30° C. dispersion containing 1 g/L of HAuCl₄ and 7 g/L of H₂SO₄ and electrodeposition is carried out at a constant voltage of 11 V (regulated with a variable autotransformer such as SLIDAC) for 5 to 6 minutes.

An example of an electrodeposition method which employs copper, tin and nickel is described in detail in Gendai Kagaku (Contemporary Chemistry), pp. 51-54 (January 1997)). Use may be made of this method as well.

The dispersions employed in the method which uses catalyst particles may be obtained by a known method. Illustrative examples include a method of preparing fine particles by low-vacuum vapor deposition and a method of preparing catalyst colloids by reducing an aqueous solution of a catalyst salt.

The colloidal catalyst particles have an average particle size of preferably 1 to 200 nm, more preferably 1 to 100 nm, and even more preferably 2 to 80 nm.

Preferred use may be made of water as the dispersion medium employed in the dispersion. Use may also be made of a mixed solvent composed of water and a solvent that is miscible with water, such as an alcohol, illustrative examples of which include ethyl alcohol, n-propyl alcohol, i-propyl alcohol, 1-butyl alcohol, 2-butyl alcohol, t-butyl alcohol, methyl cellosolve and butyl cellosolve.

No particular limitation is imposed on the technique used for coating the aluminum plate having the anodized layer with the dispersion of colloidal catalyst particles. Suitable examples of such techniques include bar coating, spin coating, spray coating, curtain coating, dip coating, air knife coating, blade coating and roll coating.

Preferred examples of the dispersion that may be employed in the method which uses colloidal catalyst particles include dispersions of gold colloidal particles and dispersions of silver colloidal particles.

Dispersions of gold colloidal particles that may be used include those described in JP 2001-89140 A and JP 11-80647 A. Use may also be made of commercial products.

Dispersions of silver colloidal particles preferably contain particles of silver-palladium alloys because these are not affected by the acids which leach out of the anodized layer. The palladium content in such a case is preferably from 5 to 30 wt %.

After the anodized aluminum plate has been coated with the dispersion, it may be suitably cleaned using a solvent such as water. As a result of such cleaning, only the catalyst particles supported in the micropores remain on the anodized layer; particles that have not been supported in the micropores are removed.

The amount of catalyst supported on the porous alumina support of the catalyst supporting body is preferably 10 to 1000 mg/m², more preferably 50 to 800 mg/M², and even more preferably 100 to 500 mg/m².

The surface porosity of the porous alumina support in the catalyst supporting body is preferably not more than 70%, more preferably not more than 50% and even more preferably not more than 30%. The “surface porosity” as used herein is defined as the sum of the areas of the openings in micropores having no catalyst supported therein relative to the surface area of the porous alumina support.

The colloidal catalyst particles which may be used in the dispersion generally have a dispersion in the particle size distribution, expressed as the coefficient of variation, of about 10 to 20%. In the practice of the invention, by setting the dispersion in pore size within a specific range, colloidal particles with dispersed particle size distribution can be efficiently used for catalyst supporting.

At a pore diameter of 50 nm or more, the method using the colloidal catalyst particles is advantageously employed. At a pore diameter of less than 50 nm, the electrodeposition is advantageously employed. Suitable use may also be made of a combination of both.

In addition to the aforementioned catalyst-supporting method relying on the electrodeposition, use may also be made of a catalyst-supporting method relying on hot water treatment as described in JP 2-144154 A.

An example of the hot water treatment includes a method in which the surface of a porous alumina support on which a catalyst is to be supported is treated with hot water or water vapor heated to 50 to 350° C. This method enables the surface area to be increased. In this case, the catalyst supporting body may not have a sufficient surface area at a temperature of less than 50° C., and a temperature in excess of 350° C. may not bring about a more excellent effect and is therefore not economical.

In consideration of shorter treatment time, hot water preferably has a pH of at least 7 and more preferably 10 to 12.

Although the treatment time in hot treatment also varies with the pH of hot water, the treatment time is preferably at least 5 minutes, more preferably at least 30 minutes and even more preferably at least 1 hour in order to sufficiently increase the surface area.

The aforementioned hot water treatment enables the surface area of the porous alumina support to be increased by a factor of about ten. As a result, the amount of catalyst that may be supported on the porous alumina is also increased by a factor of about 10.

The method described in JP 62-237947 A may be used to adhere fine particles having catalyst-supporting activity (e.g., silica and γ-alumina) onto the surface of the porous alumina support before hot water treatment is carried out. In this case, the surface area of the porous alumina support can be increased by a factor of about 1.7 compared with the case where hot water treatment is only carried out without this treatment.

The catalyst supporting body of the present invention can be used in various applications depending on the type of the catalyst used.

The catalyst supporting body of the present invention can be used in a catalyst unit. In other words, the catalyst unit of the present invention has the catalyst supporting body of the present invention.

There is no particular limitation on the catalyst unit of the present invention as long as the catalyst unit has the catalyst supporting body of the present invention. Examples of the catalyst unit include a stacked reactor for methane reforming which includes the catalyst supporting bodies of the present invention in a stacked manner, and a plasma deodorization device making use of discharge reaction.

### EXAMPLES

Examples are given below by way of illustration and should not be construed as limiting the invention.

### Examples 1 to 6 and Comparative Examples 1 and 2

### 1. Fabrication of Porous Alumina Support

A melt was prepared from an aluminum alloy composed of 0.06 wt % silicon, 0.30 wt % iron, 0.005 wt % copper, 0.001 wt % manganese, 0.001 wt % magnesium, 0.001 wt % zinc and 0.03 wt % titanium, with the balance being aluminum and inadvertent impurities. The aluminum alloy melt was subjected to molten metal treatment and filtration, then was cast into a 500 mm thick, 1,200 mm wide ingot by a direct chill casting process. The ingot was scalped with a scalping machine, removing on average 10 mm of material from the surface, then soaked and held at 550° C. for about 5 hours. When the temperature had fallen to 400° C., the ingot was rolled with a hot rolling mill to a plate thickness of 2.7 mm. In addition, heat treatment was carried out at 500° C. in a continuous annealing furnace, after which cold rolling was carried out to finish the aluminum plate to a thickness of 0.24 mm thereby obtaining a JIS 1050 aluminum plate. This aluminum plate was cut into a width of 1030 mm and subjected to the surface treatments described below to yield porous alumina supports.

Of the following surface treatments (a) to (j), those indicated with “YES” in Table 1 was successively carried out on the aluminum plates in order from the left side of Table 1. Note that nip rollers were used to remove the solution or water after each treatment or rinsing treatment was carried out.

(a) Mechanical Graining Treatment

The apparatus as shown in FIG. 4 was used to carry out mechanical graining treatment which involved rotating nylon brush rollers while an aqueous suspension containing an abrasive (pumice) (specific gravity: 1.12) was supplied to the surface of each aluminum plate as the abrasive slurry. FIG. 4 shows an aluminum plate 1, brush rollers 2 and 4, an abrasive slurry 3, and support rollers 5, 6, 7 and 8. The abrasive had an average particle size of 40 μm and a maximum particle size of 100 μm. The nylon brush was made of nylon 6.10 and had a bristle length of 50 mm and a bristle diameter of 0.3 mm. For the nylon brush, the bristles were tightly packed in holes formed in a stainless steel cylinder having a diameter of 300 mm. Three rotating brush rollers were used. The distance between the two support rollers (diameter: 200 mm) under each of the brush rollers was 300 mm. The brush rollers were pressed against an aluminum plate until the load of the drive motor for rotating the brush rollers increased by 7 kW from the state in which the brush rollers had not yet been pressed against the aluminum plate. The direction of rotation of the brush roller in the portion where the brush roller contacted the aluminum plate was the same as the direction in which the aluminum plate was moved. The brush rollers were rotated at 200 rpm.

(b) Alkali Etching Treatment

Etching was carried out by spraying each aluminum plate with an aqueous solution having a sodium hydroxide concentration of 2.6 wt %, an aluminum ion concentration of 6.5 wt % and a temperature of 70° C., whereby 6 g/m² of material was dissolved out of the aluminum plate. Then, each aluminum plate was sprayed with water for rinsing.

(c) Desmutting Treatment

Desmutting was carried out by spraying each aluminum plate with an aqueous solution having a nitric acid concentration of 1 wt %, an aluminum ion concentration of 0.5 wt % and a temperature of 30° C. Thereafter, each aluminum plate was sprayed with water for rinsing. Wastewater from the electrochemical graining treatment step carried out with an alternating current in a nitric acid aqueous solution was used as the nitric acid aqueous solution for desmutting treatment.

(d) Electrochemical Graining Treatment

An alternating current with a frequency of 60 Hz was continuously passed through each aluminum plate to carry out electrochemical graining treatment. An aqueous solution containing 10.5 g/L of nitric acid (5 g/L of aluminum ions and 0.007 wt % of ammonium ions) was used as the electrolytic solution at a temperature of 50° C. An alternating current having a trapezoidal waveform as shown in FIG. 1 was applied across the carbon electrodes serving as the counter electrode to carry out electrochemical graining treatment. The time TP until the current reached a peak from zero was 0.8 ms and the duty ratio was 1:1. Ferrite was used for the auxiliary anode. The electrolytic cell as shown in FIG. 2 was used. The current density at the alternating current peaks was 30 A/dm². The total amount of electricity when the aluminum plate served as an anode was 220 C/dm². To the auxiliary anodes was diverted 5% of the current from the power supply. Then, each aluminum plate was sprayed with water for rinsing.

(e) Alkali Etching Treatment

Etching was carried out by spraying each aluminum plate with an aqueous solution having a sodium hydroxide concentration of 26 wt % and an aluminum ion concentration of 6.5 wt % at a temperature of 32° C., whereby 1.0 g/m² of material was dissolved out of the aluminum plate. Thus, the aluminum hydroxide-based smut component generated when electrochemical graining treatment was carried out using the alternating current in the previous step was removed, and edges of pits formed by electrochemical graining treatment were dissolved and given smooth surfaces. Then, each aluminum plate was sprayed with water for rinsing.

(f) Desmutting Treatment

Desmutting was carried out by spraying each aluminum plate with an aqueous solution having a sulfuric acid concentration of 15 wt %, an aluminum ion concentration of 4.5 wt % and a temperature of 30° C. Then, each aluminum plate was sprayed with water for rinsing. Wastewater from the electrochemical graining treatment step carried out with an alternating current in a nitric acid aqueous solution was used as the nitric acid aqueous solution for desmutting treatment.

(g) Electrochemical Graining Treatment

An alternating current with a frequency of 60 Hz was continuously passed through each aluminum plate to carry out electrochemical graining treatment. An aqueous solution containing 7.5 g/L of hydrochloric acid (and 5 g/L of aluminum ions) was used as the electrolytic solution at a temperature of 35° C. An alternating current having a trapezoidal waveform as shown in FIG. 1 was applied across the carbon electrodes serving as the counter electrode to carry out electrochemical graining treatment. The time TP until the current reached a peak from zero was 0.8 ms and the duty ratio was 1:1. Ferrite was used for the auxiliary anode. The electrolytic cell as shown in FIG. 2 was used. The current density at the alternating current peaks was 25 A/dm². The total amount of electricity when the aluminum plate served as an anode was 50 C/dm². Then, each aluminum plate was sprayed with water for rinsing.

(h) Alkali Etching Treatment Etching was carried out by spraying each aluminum plate with an aqueous solution having a sodium hydroxide concentration of 26 wt % and an aluminum ion concentration of 6.5 wt % at a temperature of 32° C., whereby 0.1 g/m² of material was dissolved out of the aluminum plate. Thus, the aluminum hydroxide-based smut component generated when electrochemical graining treatment was carried out using the alternating current in the previous step was removed, and edges of pits formed by electrochemical graining treatment were dissolved and given smooth surfaces. Then, each aluminum plate was sprayed with water for rinsing.

(i) Desmutting Treatment

Desmutting was carried out by spraying each aluminum plate with an aqueous solution having a sulfuric acid concentration of 25 wt %, an aluminum ion concentration of 0.5 wt % and a temperature of 60° C. Then, each aluminum plate was sprayed with water for rinsing.

(j) Anodizing Treatment

An anodizing apparatus of the structure as shown in FIG. 3 was used to carry out anodizing treatment. Sulfuric acid was used for the electrolytic solution for supplying to the two cells. Each electrolytic solution contained 170 g/L of sulfuric acid (and 0.5 wt % of aluminum ions) and had a temperature of 38° C. Then, each aluminum plate was sprayed with water for rinsing. The final weight of the anodized layer was 2.7 g/m².

2. Measurement of Surface Profile of Porous Alumina Support Measurement as indicated in (1) to (3) below was performed on the surface topography of the porous alumina support obtained in the aforementioned steps to calculate the respective average wavelengths of the large-, medium- and small-wave structures.

The results are shown in Table 1. In Table 1, a dash “-” indicates that there were no irregularities of a corresponding average wavelength.

(1) Average Wavelength of Large-Wave Structure

Two-dimensional roughness measurement was conducted using a stylus-type roughness tester (e.g., Surfcom 575 manufactured by Tokyo Seimitsu Co., Ltd.). The mean spacing Sₘ as defined by ISO 4287 was measured five times, and the mean of the five measurements was used as the value of the average wavelength.

The conditions of the two-dimensional roughness measurement are described below.

<Measurement Conditions>

Cutoff value, 0.8 mm; slope correction, FLAT-ML; measurement length, 3 mm; vertical magnification, 10,000×; scan rate, 0.3 mm/s; stylus tip diameter, 2 μm.

(2) Average Wavelength of Medium-Wave Structure

The surface of each porous alumina support was photographed from just above with a scanning electron microscope (SEM) at a magnification of 2,000×. From the image obtained by the SEM, 50 pits of the medium-wave structure which were connected to one another in an annular shape were extracted and their diameters were read for the wavelength. The average wavelength was then calculated.

(3) Average Wavelength of Small-Wave Structure

The surface of each porous alumina support was photographed from just above with a high-resolution SEM at a magnification of 50,000×, and 50 pits of the small-wave structure were extracted from the image obtained by the SEM. Their diameters were read for the wavelength and the average wavelength was then calculated.

### 3. Calculation of Factor for Surface Profile of Porous Alumina Support

The surface profile was measured with an atomic force microscope (SP13700 manufactured by Seiko Instruments & Electronics Ltd.) to obtain three-dimensional data, thereby determining the difference in surface area ΔS on the surface of each porous alumina support obtained as described above. The procedure is described below in further detail.

A 1 cm square sample was cut out from each porous alumina support and placed on a horizontal sample holder on a piezo scanner. A cantilever was made to approach the surface of the sample. When the cantilever reached the zone where interatomic forces were appreciable, the surface of the sample was scanned in the X and Y directions and the surface topography of the sample was read based on the displacement in the Z direction. The piezo scanner used was capable of scanning 150 μm in the X and Y directions and 10 μm in the Z direction. The cantilever used had a resonance frequency of 120 to 150 kHz and a spring constant of 12 to 20 N/m (SI-DF20 manufactured by NANOPROBE). Measurement was carried out in the dynamic force mode (DFM). The three-dimensional data obtained was approximated by the least-squares method to compensate for slight tilting of the sample and determine a reference plane.

Measurement involved obtaining values of 50 μm square regions of the surface of the sample at 512 by 512 points. The resolution was 1.9 μm in the X and Y directions, and 1 nm in the Z direction, and the scan rate was 60 μm/s.

The three-dimensional data f (x,y) obtained above was used to extract sets of adjacent three points. The surface areas of microtriangles formed by the sets of three points were summated, thereby giving the actual surface area Sₓ. The difference in surface area ΔS was then calculated from the resulting actual surface area Sₓ and the geometrically measured surface area S₀ using the equation (1) as defined in the specification.

The results are shown in Table 1.

### 4. Supporting of Catalyst

In Examples 1 to 4 and Comparative Example 1, the porous alumina support obtained as described above was immersed in a 30° C. dispersion containing 1 g/L of HPtCl₄ and 7 g/L of H₂SO₄ and electrodeposition was carried out at a constant voltage of 11 V (regulated with a variable autotransformer such as SLIDAC) for 5 minutes to support a platinum catalyst on the surface of the porous alumina support thereby obtaining a catalyst supporting body.

In Examples 5 and 6, the porous alumina support obtained as described above was treated as follows: First, 1.5 mL of an aqueous solution containing 1 wt % of citric acid was added to 1.5 mL of an aqueous solution containing 0.05 wt % of HAuCl₄. The resulting mixture was gradually heated from room temperature using an alcohol lamp. Heating was discontinued when the solution changed to a red-violet color, after which the solution was cooled to room temperature, yielding a gold colloidal particle dispersion (average size of gold colloidal particles, 120 nm). The porous alumina support was subsequently immersed in the dispersion for 1 minute, then rinsed with water and dried. A gold catalyst was then supported on the surface of the porous alumina support to obtain a catalyst supporting body. In Comparative Example 2, a catalyst supporting body was obtained by repeating the method used in Examples 5 and 6 except that the support was immersed for 20 seconds.

For each of the resulting catalyst supporting bodies, the amount of catalyst supported per unit area was measured with an electron probe microanalyser (EPMA). The results are shown in Table 1.

### 5. Measurement of Catalytic Function of Catalyst Supporting Body

To check the catalytic function of the resulting catalyst supporting body, 10 moles of cyclohexane was blown onto the surface of the catalyst supporting body as a mist in a 250° C., 1 atmosphere environment, following which the volatilized components were captured. The captured volatilized components were liquefied by cooling and recovered, and the conversion (%) of cyclohexane to cyclohexene, cyclohexadiene or benzene was determined by liquid chromatography. A higher conversion indicates higher catalytic function. The results are shown in Table 1.

As is clear from Table 1, the catalyst supporting bodies of the present invention (as in Examples 1 to 6) have an excellent catalytic function compared with the case where a porous alumina support having no irregularities formed on the surface thereof was used (as in Comparative Examples 1 and 2).

In particular, the comparison between Example 6 and Comparative Example 2 shows that the catalyst supporting body of the present invention (as in Example 6) has an excellent catalytic function compared with the case where a porous alumina support having no irregularities formed on the surface thereof was used (as in Comparative Example 2).

TABLE 1

| | | | | | | | | | | | | Average wavelength | | | | | |
|---|---|---|---|---|---|---|---|---|---|---|---|---|---|---|---|---|---|
| | | | | | | | | | | | | (μm) | | | Type | Amt. of | |
| | | | | | | | | | | | | Large- | Medium- | Small- | of | supported | Conver- |
| | Treatment | | | | | | | | | | ΔS | wave | wave | wave | cata- | catalyst | sion |
| | (a) | (b) | (c) | (d) | (e) | (f) | (g) | (h) | (i) | (j) | (%) | structure | structure | structure | lyst | (g/m²) | (%) |
| EX1 | YES | YES | YES | YES | YES | YES | YES | YES | YES | YES | 54 | 20 | 2.0 | 0.08 | Pt | 0.7 | 97 |
| EX2 | YES | YES | YES | YES | YES | YES | | | | YES | 25 | 20 | 2.0 | — | Pt | 0.4 | 86 |
| EX3 | YES | YES | YES | | | | YES | YES | YES | YES | 40 | 20 | — | 0.08 | Pt | 0.6 | 84 |
| EX4 | | | | YES | YES | YES | YES | YES | YES | YES | 42 | — | 2.0 | 0.08 | Pt | 0.7 | 81 |
| EX5 | YES | YES | YES | | | | | | | YES | 11 | 20 | — | — | Au | 0.3 | 77 |
| EX6 | | | | YES | YES | YES | | | | YES | 13 | — | 2.0 | — | Au | 0.2 | 74 |
| CE1 | | | | | | | | | | YES | 4 | — | — | — | Pt | 0.2 | 42 |
| CE2 | | | | | | | | | | YES | 4 | — | — | — | Au | 0.2 | 38 |

What is claimed is:

1. A catalyst supporting body comprising:
a porous alumina support; and
a catalyst supported on the porous alumina support,
wherein a surface of the porous alumina support has at least one selected from the group consisting of irregularities having an average wavelength of 5 to 100 μm, irregularities having an average wavelength of 0.5 to 5 μm, and irregularities having an average wavelength of 0.01 to 0.5 μm.

2. The catalyst supporting body according to claim 1, wherein the surface of the porous alumina support has a difference in surface area ΔS represented by formula (1):
ΔS=[(Sₓ−S₀)/S₀]×100 (%) (1)
wherein Sₓ is the actual surface area of a 50 μm square surface region as determined by three-point approximation from three-dimensional data on the surface region measured with an atomic force microscope at 512×512 points and S₀ is the geometrically measured surface area of the surface region, of at least 5%.

3. A catalyst unit having the catalyst supporting body according to claim 1.

4. A catalyst unit having the catalyst supporting body according to claim 2.
